(19) United States
(12) Patent Application Publication
(10) Pub. No.: US 2025/0077441 A1
(43) Pub. Date: Mar. 6, 2025

(54) CACHING USING MACHINE LEARNED PREDICTIONS

(71) Applicant: Google LLC, Mountain View, CA (US)

(72) Inventors: Sergei Vassilvitskii, San Francisco, CA (US); Theodoros Lykouris, Ithaca, NY (US)

(21) Appl. No.: 18/949,822

(22) Filed: Nov. 15, 2024

Related U.S. Application Data
(63) Continuation of application No. 15/954,809, filed on Apr. 17, 2018, now abandoned.
Application No. 15/954,809 is a continuation of application No. PCT/GR2018/000005, filed on Feb. 12, 2018.

(51) Int. Cl. G06F 12/121; G06F 12/127; G06N 3/044; G06N 20/00

(52) U.S. Cl. CPC G06F 12/121; G06F 12/127; G06N 3/044; G06N 20/00; G06F 2212/1044

(57) ABSTRACT

Methods, systems, and apparatus, including computer programs encoded on computer storage media, for evicting cache data using machine learning. One of the methods includes determining that particular data is not stored in a cache that is full; determining, using information for the particular data, a predicted eviction accuracy of a machine learning system; determining whether the predicted eviction accuracy of the machine learning system satisfies a threshold eviction accuracy; and in response to determining that the predicted eviction accuracy of the machine learning system satisfies the threshold eviction accuracy: sending, to the machine learning system, a request for an identifier for data stored in the cache; receiving, from the machine learning system, an identifier for data stored in the cache; evicting the data referenced by identifier from a location in the cache; and storing the particular data at the location in the cache.

### CROSS-REFERENCE TO RELATED APPLICATIONS

This application is a continuation of U.S. application Ser. No. 15/954,809, filed on Apr. 17, 2018, which is a continuation of PCT Application No. PCT/GR2018/000005, filed on Feb. 12, 2018, the contents of each are incorporated by reference herein.

### BACKGROUND

Some systems use caching to store recently accessed data that may be used again. A system may cache data in a fast memory so the data can be accessed more quickly than retrieval from a slower memory, e.g., a hard disk drive or a solid state drive, or so that the data does not have to be recomputed.

### SUMMARY

A system may use machine learning to reduce a frequency at which data is evicted from a cache but is later needed before other data in the cache, which could have been evicted instead of the data, is accessed. For instance, when a system retrieves data that is not currently stored in a cache, the system may determine which data in the cache has not recently been accessed and use a machine learning system to select some data that has not recently been accessed to evict from the cache and allow for storage of the retrieved data in the cache. Use of the machine learning system to determine which data to evict may improve system cache performance, e.g., reduce a cache miss rate.

In some implementations, a system may use a combination of a machine learning system and random eviction to determine which data to evict. For example, the system may determine a predicted eviction accuracy of the machine learning system. If the predicted eviction accuracy satisfies a threshold eviction accuracy, the system uses the machine learning system to determine which data to evict from the cache. If the predicted eviction accuracy does not satisfy the threshold eviction accuracy, the system uses a random eviction process to determine which data to evict from the cache.

In some examples, the system may use another process to determine which data to evict instead of a random eviction process when the predicted eviction accuracy does not satisfy the threshold eviction accuracy. For instance, the system may evict the least recently used data; the data that was placed in the cache at the earliest time, e.g., using a first-in, first-out process; or another eviction process.

The predicted eviction accuracy of the machine learning system may be based on the data not currently stored in the cache but will be stored in the cache after eviction of data currently stored in the cache. For instance, the system may have data s₁, s₂, and s₃ stored in the cache and receive data c that is responsive to a data request and needs to be stored in the cache. The machine learning system may determine that out of data s₁, s₂, and s₃, that the data s₁ will most likely be accessed after data s₂ and s₃ and to evict data s₁ from the cache to allow for storage of the data c in the cache. When the system next receives a request for the data s₁, the machine learning system will need to select which of the data s₂ or the data s₃ to evict from the cache. If the system evicts the data s₂ from the cache but later receives a request for the data s₂, the system can use information about the previous eviction of the data s₁ and the data s₂, e.g., a quantity of previous related evictions identified by a data set chain as described in more detail below, to determine whether to use the machine learning system or a non-machine learning process, e.g., a random eviction process, to determine which data to evict. Use of the predicted eviction accuracy when determining which data to evict from a cache may reduce a likelihood that the system will use inaccurate machine learning system eviction recommendations, may improve system cache performance by maintaining data in the cache that will be accessed before data selected for eviction, or both. In some implementations, using of a machine learning system may, on the whole, allow the system to make better eviction decisions, e.g., reduce a cache miss rate, while use of a non-machine learning process may prevent the system from using a number of related bad eviction recommendations from the machine learning system, e.g., set a maximum threshold to the cache miss rate.

The system may be any appropriate type of system that uses caching. For instance, the system may cache web search results and use a machine learning system to determine which cached web search results to evict given a limited amount of memory within which to store the web search results. In some examples, the system may be an operating system on a device that determines which data to evict from a cache, e.g., a main memory that stores pages of data. The system may be a processor or another device that stores frequently accessed data in a fast memory, e.g., that is included in the system.

The system may use any appropriate machine learning system. For example, the system may use a machine learning system that performs regression analysis. In some examples, the system may use a neural network to determine which data to evict. The neural network can be a recurrent neural network (“RNN”), a long short-term memory (“LSTM”) neural network, or another appropriate type of neural network.

In general, one innovative aspect of the subject matter described in this specification can be embodied in methods that include the actions of determining that particular data is not stored in a cache that is full; in response to determining that the particular data is not stored in the cache that is full, determining, using information for the particular data, a predicted eviction accuracy of a machine learning system; in response to determining the predicted eviction accuracy of the machine learning system, determining whether the predicted eviction accuracy of the machine learning system satisfies a threshold eviction accuracy; and in response to determining that the predicted eviction accuracy of the machine learning system satisfies the threshold eviction accuracy: sending, to the machine learning system, a request for an identifier for data stored in the cache; receiving, from the machine learning system, an identifier for data stored in the cache; in response to receiving the identifier for the data stored in the cache, evicting the data referenced by identifier from a location in the cache; and storing the particular data at the location in the cache. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In general, one innovative aspect of the subject matter described in this specification can be embodied in methods that include the actions of receiving, for each of two or more data sets, a request to store the respective data set in a cache that is full and is not currently storing the respective data set; for each of the two or more data sets: in response to receiving the request to store the respective data set, determining, using information for the respective data set, a predicted eviction accuracy of a machine learning system; in response to determining the predicted eviction accuracy of the machine learning system, determining whether the predicted eviction accuracy of the machine learning system satisfies a threshold eviction accuracy; in response to determining that the predicted eviction accuracy of the machine learning system satisfies the threshold eviction accuracy for each of one or more first data sets from the two or more data sets: sending, to the machine learning system, a request for an identifier for a data set stored in the cache; receiving, from the machine learning system, an identifier for a selected data set stored in the cache; in response to receiving the identifier for the selected data set stored in the cache, evicting the selected data set referenced by identifier from a location in the cache; and storing the respective data set at the location in the cache; and in response to determining that the predicted eviction accuracy of the machine learning system does not satisfy the threshold eviction accuracy for each of one or more second data sets from the two or more data sets: evicting a random data set from a location in the cache; and storing the respective data set at the location in the cache. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In general, one innovative aspect of the subject matter described in this specification can be embodied in methods that include the actions of determining, for each of two or more data sets, that the respective data set is not stored in a cache that is full; for each of the two or more data sets: determining, using information for the respective data set, a predicted eviction accuracy of a machine learning system; in response to determining the predicted eviction accuracy of the machine learning system, determining whether the predicted eviction accuracy of the machine learning system satisfies a threshold eviction accuracy; in response to determining that the predicted eviction accuracy of the machine learning system satisfies the threshold eviction accuracy for each of one or more first data sets from the two or more data sets: sending, to the machine learning system, a request for an identifier for a data set stored in the cache; receiving, from the machine learning system, an identifier for a selected data set stored in the cache; in response to receiving the identifier for the selected data set stored in the cache, evicting the data set referenced by identifier from a location in the cache; and storing the respective data set at the location in the cache; and in response to determining that the predicted eviction accuracy of the machine learning system does not satisfy the threshold eviction accuracy for each of one or more second data sets from the two or more data sets: selecting a data set for eviction from the cache using a non-machine learning process; evicting the selected data set from a location in the cache; and storing the respective data set at the location in the cache. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Determining, using information for the particular data, the predicted eviction accuracy of the machine learning system may include determining a cache miss rate for a data set chain that includes data sets the machine learning system previously identified for eviction from the cache, the data set chain including the particular data. Determining the cache miss rate for the data set chain that includes data sets the machine learning system previously identified for eviction from the cache may include determining whether a quantity of data sets identified by the data set chain satisfies a threshold value.

In some implementations, receiving, from the machine learning system, the identifier for data stored in the cache may include receiving the identifier for data stored in the cache that has not been accessed within a particular time period. The method may include determining whether the particular data was previously stored in the cache during a second time period preceding and adjacent to the particular time period without any intervening time periods; in response to determining that the particular data was not previously stored in the cache during the second time period, creating a new data set chain that identifies the data stored in the cache for which the identifier was received from the machine learning system. The method may include determining whether the particular data was previously stored in the cache during a second time period preceding and adjacent to the particular time period without any intervening time periods; in response to determining that the particular data was previously stored in the cache during the second time period: determining a data set chain that identifies the particular data; and updating the data set chain to identify the data stored in the cache for which the identifier was received from the machine learning system. Determining, using the information for the particular data, the predicted eviction accuracy of the machine learning system may include determining the predicted eviction accuracy using a quantity of data sets identified by data set chain.

In some implementations, receiving the identifier for data stored in the cache that has not been accessed within the particular time period may include receiving the identifier for data stored in the cache that is not tagged as having been accessed within the particular time period. Storing the particular data at the location in the cache may include tagging the data as having been accessed within the particular time period. The method may include determining whether all of the data stored in the cache has been accessed within the particular time period; in response to determining that all of the data stored in the cache has been accessed within the particular time period: initiating a new time period that begins after the particular time period; and updating the tags for the data stored in the cache so that the data is not tagged as having been accessed within the new time period and the machine learning system can identify the data that is not tagged as having been accessed within the new time period in response to another request for an identifier for data stored in the cache. Sending, to the machine learning system, the request for an identifier for data stored in the cache may include sending, to the machine learning system, the request for an identifier for data stored in the cache that includes data indicating which data stored in the cache is not tagged as having been accessed within the particular time period. Sending, to the machine learning system, the request for an identifier for data stored in the cache may include sending, to the machine learning system, the request for an identifier for data stored in the cache that includes historical data indicating, for at least some of the data stored in the cache, when the respective data was accessed.

In some implementations, the machine learning system may be a regression analysis system. The regression analysis system may be a neural network analysis system, a recurrent neural network analysis system, or a long short-term memory neural network system. In some implementations, a system that performs the method may include the cache. In some implementations, a data processing apparatus that performs the method may be a processor or one or more computers.

In some implementations, selecting the data set for eviction from the cache using the non-machine learning process may include selecting the data set for eviction using a random replacement selection process; a least recently used selection process; a first-in, first-out selection process; a last-in, first-out selection process; a most recently used selection process; a least frequently used selection process; or an adaptive replacement selection process. Receiving, from the machine learning system, the identifier for the selected data set stored in the cache may include receiving an identifier for a selected data set stored in the cache that has not been accessed within a particular time period. The method may include determining, for each of the two or more data sets, whether the respective data set was previously accessed during a second time period preceding and adjacent to the particular time period without any intervening time periods while the respective data set was stored in the cache; for each of one or more third data sets from the two or more data sets in response to determining that the respective data set was not previously accessed during the second time period: sending, to the machine learning system, a request for an identifier for a data set stored in the cache; receiving, from the machine learning system, an identifier for a selected data set stored in the cache; in response to receiving the identifier for the selected data set stored in the cache: creating a new data set chain that identifies the selected data set stored in the cache for which the identifier was received from the machine learning system; evicting the selected data set referenced by identifier from a location in the cache; and storing the respective data set at the location in the cache; and for each of the first data sets and each of the second data sets in response to determining that the respective data set was previously accessed during the second time period while the respective data set was stored in the cache: determining a data set chain that identifies the respective data; and determining a quantity of data sets identified by the data set chain. Determining, using the information for the respective data set, the predicted eviction accuracy of the machine learning system may include determining the predicted eviction accuracy using the quantity of identifiers included in the data set chain. Storing, for each of the first data sets and each of the second data sets, the respective data set at the location in the cache may include updating the data set chain to identify the selected data set evicted from the cache.

The subject matter described in this specification can be implemented in various embodiments and may result in one or more of the following advantages. In some implementations, use of a machine learning process to determine data eviction, or a combination of a machine learning process with another process as described below, may have a worst case eviction rate that is as good as the eviction rates of other systems, a best case eviction rate that is better than the eviction rates of other systems, or both. In some implementations, use of a machine learning process to determine data eviction, or a combination of a machine learning process with another process as described below, may reduce a likelihood that data in a cache that will be accessed sooner than other data in the cache will be evicted, may reduce a cache miss rate, or both. In some implementations, use of a machine learning process to determine data eviction, or a combination of a machine learning process with another process as described below, may improve the speed at which a system responds to data requests. Each of these advantages result in respective technological improvements in the technical field of computer memory management.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example of a caching system that receives data from a machine learning system that indicates a data set to evict from a cache.

FIG. 2 is a flow diagram of a process for determining a process to use to select data to evict from a cache.

FIG. 3 is a block diagram of a computing system that can be used in connection with computer-implemented methods described in this document.

Like reference numbers and designations in the various drawings indicate like elements.

### DETAILED DESCRIPTION

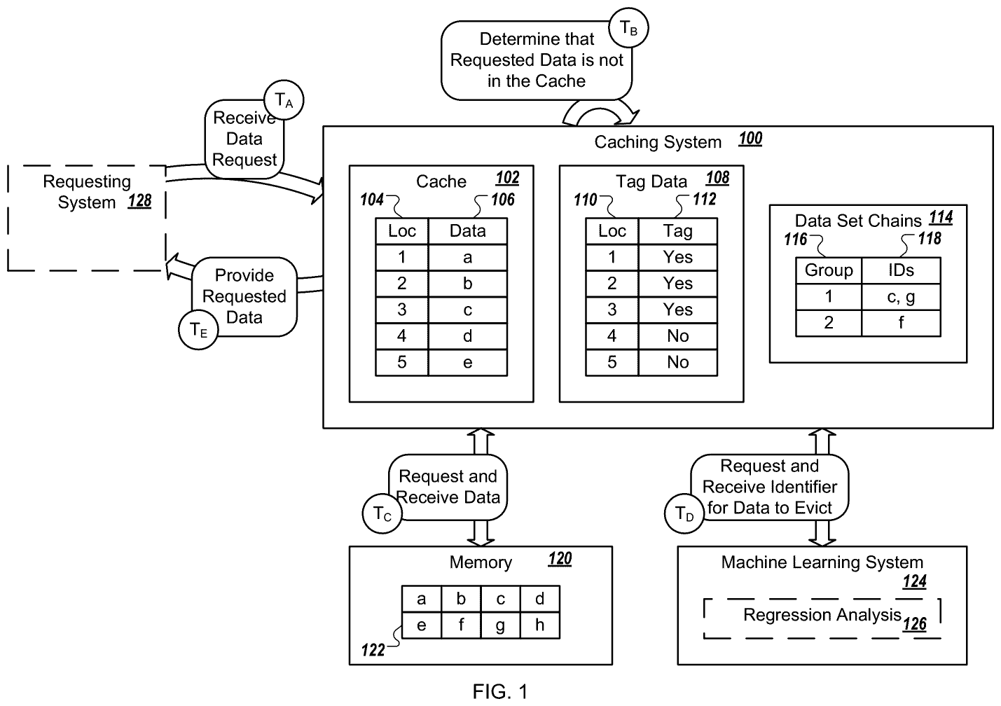

FIG. 1 is an example of a caching system 100 that receives identifying data from a machine learning system 124 that indicates a data set 106 to evict from a cache 102. The caching system 100 uses the machine learning system 124 to reduce a number of cache misses when processing data requests, e.g., to improve the average speed at which the caching systems 100 provides data in response to requests for the data.

The caching system 100 may use a process with phases, e.g., time periods, when evicting a data set 106, e.g., data, from the cache. For example, in the beginning of each phase, the caching system 100 may tag 112 each data set 106 stored in the cache 102 to indicate that the data set was not accessed during the current phase. When the caching system 100 receives a read or write request for a data set already stored in the cache 102, the caching system 100 tags 112 the data set as having been accessed during the current phase.

If the data set is not in the cache 102, the caching system 100 selects a data set that is not tagged 112 for eviction from the cache 102, as described in more detail below, and stores the data set in the cache 102 at a location 104 previous occupied by the evicted data set. The caching system 100 tags 112 the newly stored data set as having been accessed during the current phase.

Once the caching system 100 tags 112 all of the data sets stored in the cache 102 as having been accessed during the current phase and a new cache miss occurs, e.g., the caching system 100 receives a read or write request for a data set not stored in the cache 102, the caching system 100 ends the current phase, e.g., the current time period, begins a new phase, and removes any tags for the data sets.

For example, the caching system 100 may receive a data request from a requesting system 128 during time period T_{A}. The data request may be a request to store a data set in the cache 102, a read request for a data set, or another appropriate type of data request. In some examples, the request may be for a data set stored in a memory 120 that includes data sets “a” through “h” 122 and is a separate memory from the cache 102.

During time period T_{B}, the caching system 100 determines that the requested data set is not stored in the cache 102. The caching system 100 may use any appropriate process to determine whether the requested data set is stored in the cache 102. For instance, the caching system 100 may check each location 104 in the cache 102 to determine whether the requested data set is one of the data sets 106 stored in the cache 102. When the caching system 100 determines that the requested data set is stored in the cache 102, the caching system 100 tags the requested data set as having been accessed during the current phase if the requested data set does not already include the tag. For instance, the caching system 100 updates tag data 108 to indicate that the requested data set was accessed during the current phase. The caching system 100 may process another data request.

When the caching system 100 determines that the requested data set is not stored in the cache 102, the caching system 100 requests the data set from the memory 120 during time period T_{C}. In response to sending the request to the memory 120, the memory 120 accesses the requested data set and provides the requested data set to the caching system 100 during time period T_{C}.

The memory 120 may be any appropriate type of memory. For example, when the cache 102 is a processor cache, the memory 120 may be a random access memory (“RAM”), a solid state drive (“SSD”), or a hard disk drive (“HDD”).

When the caching system 100 determines that the requested data set is not stored in the cache 102, the caching system 100 determines an eviction process to use when selecting a data set to evict from the cache 102. The caching system 100 uses the determined eviction process to select a data set that has not been tagged 112 during the current phase for eviction. For instance, the caching system 100 may include tag data 108 with location identifiers 110 for each location 104 in the cache 102, and a tag 112 that indicates whether a data set in the corresponding location 104 in the cache 102 has been accessed, e.g., a read access or a write access or both, during the current phase. The caching system 100 may store the tag data 108 in a portion of the cache 102 or in another memory of the caching system 100.

The caching system 100 may use information that indicates whether the requested data was accessed during a previous phase when determining an eviction process to use when selecting data to evict from the cache 102. For example, when the caching system 100 begins a phase the cache 102 may include data sets {c, f, g, d, e}. For the first cache miss, the caching system 100 receives a request for data set “a” which was not accessed from the cache 102 during the previous phase, e.g., is a “clean” data set, because only the data sets “c,” “d,” “e,” “f,” and “g” were accessed, e.g., during a read or a write access or both, in the cache 102 during the previous phase. A data set that was accessed during the previous phase, e.g., the data sets “c,” “d,” “e,” “f,” and “g”, is a stale data set for the current phase.

In response to determining that the data set “a” is clean, the caching system 100 requests, during time period T_{D}, an identifier from the machine learning system 124 that indicates a recommendation for a data set 106 to evict from the cache 102 to allow storage of the requested data in the cache 102. The identifier may be any appropriate identifier for a data set, such as a location 104 in the cache 102 at which the data set is stored, an identifier specific to the recommended data set for eviction, e.g., a memory address at which the data set is stored in the memory 120, or another appropriate identifier. For instance, the caching system 100 may receive, from the machine learning system 124, a location identifier 104 for the data set “c” to evict from the cache 102. The caching system 100 may receive identifiers from the machine learning system 124 that only indicate one of the data sets that is not tagged in the tag data 108. For example, when none of the data sets “c,” “d,” “e,” “f,” and “g” are tagged, the caching system 100 can receive an identifier for any of those data sets from the machine learning system 124. If only the data sets “c,” “d,” “e” were not tagged, the caching system 100 can receive only an identifier for any of those data sets from the machine learning system 124.

The caching system 100 receives the requested data set from the memory 120, during time period T_{C}, and receives the identifier for the recommended data set to evict from the machine learning system 124 during time T_{D}. The caching system 100 can then evict the identified data set, e.g., data set “c”, from the cache 102 and store the received data set, e.g., the data set “a”, in the cache location 104 at which the evicted data set was previously stored, e.g., the location “1” in the cache 102. After storing the requested data set, e.g., the data set “a”, in the cache 102, the caching system 100 tags the requested data set, e.g., by updating the tag 112 in the tag data 108 to indicate that the requested data set was accessed during the current phase. The caching system 100 may use any appropriate method to tag the requested data set. For instance, the caching system 100 may add or update a tag for the requested data to indicate a binary value, such as “1”, to represent that “yes” the requested data set was accessed during the current phase.

The caching system 100 may create a data set chain 114 that identifies the evicted data set, e.g., the data set “c.” When the requested data set is “clean,” the caching system 100 may create a new data set chain 114, e.g., with a new chain group 116, for the newly evicted data. For example, the caching system 100 may create the data set chain group 1 that includes an identifier 118 for the evicted data set “c” or otherwise identifies the evicted data set, e.g., by including an address from the memory 120 at which the data set “c” 122 is stored.

In response to determining that a requested data set “c” is not stored in the cache 102 and is stale, e.g., and was accessed during the previous phase, the caching system 100 determines a predicted eviction accuracy of the machine learning system 124. The predicted eviction accuracy of the machine learning system 124 may be specific to the requested data set, e.g., the data set “c,” a data set chain that includes the requested data set, e.g., the first data set chain, or other data for the requested data set. For instance, the caching system 100 may use the data set chains 114 to determine a predicted eviction accuracy for the machine learning system 124. For instance, when a quantity of data sets identified by a data set chain satisfies a threshold value, as discussed in more detail below, the caching system 100 may determine that the predicted eviction accuracy for the machine learning system 124 satisfies a threshold eviction accuracy and to evict a data set identified by the machine learning system 124 instead of a data set identified using another process. The quantity of data sets identified by a data set chain may satisfy a threshold value when the quantity is less than the threshold value, equal to the threshold value, or either. One example of a threshold value is the harmonic number Hₖ based on the number of cache locations in the cache 102. For example, when the cache includes five locations, the threshold value may be

$${H}_{5} = 1 + \frac{1}{2} + \frac{1}{3} + \frac{1}{4} + \frac{1}{5} = 2 \frac{17}{60} .$$

When the predicted eviction accuracy satisfies a threshold eviction accuracy, the caching system 100 may evict a data set selected by the machine learning system 124 to allow for storage of the requested data set in the cache 102. When the predicted eviction accuracy does not satisfy the threshold eviction accuracy, the caching system 100 may use another process to select a data set to evict from the cache 102. In some examples, the threshold eviction accuracy and the predicted eviction accuracy may be percentages. The predicted eviction accuracy may represent a recent historical predicted eviction accuracy of the machine learning system 124 in predicted a data set to evict from the cache 102 that will be used further in the future than the other data sets current stored in the cache 102. In some examples, the predicted eviction accuracy may be a real number, e.g., a quantity of data set identified by a data set chain.

The caching system 100 may determine a predicted eviction accuracy using a data set chain 114 for the requested data, e.g., the data set “c.” For instance, the caching system 100 may determine the first data set chain from the data set chains 114 that identifies the requested data set, e.g., the data set “c.” The caching system 100 may determine whether a quantity of data sets identified by the first data set chain satisfies a threshold value.

When the quantity satisfies the threshold value, e.g., is less than the threshold value or equal to the threshold value or either, the caching system 100 requests, from the machine learning system 124 during time period T_{D}, an identifier of a data set to evict from the cache. In response to receiving the identifier of a data set from the machine learning system 124 during time period T_{D}, the caching system 100 evicts the identified data set, e.g., the data set “g,” and places the requested data, e.g., the data set “c,” in the location at which the evicted data set was previously stored in the cache 102.

If the predicted eviction accuracy does not satisfy the threshold prediction accuracy, the caching system 100 uses another process to determine which data set to evict from the cache 102. The caching system 100 may use a non-machine learning process as the other process with which to determine a data set to evict from the cache 102. The non-machine learning process may be a random replacement selection process; a least recently used selection process; a first-in, first-out selection process; a last-in, first-out selection process; a most recently used selection process; a least frequently used selection process; or an adaptive replacement selection process.

In some implementations, the caching system 100 may provide the machine learning system 124 with historical data for the data sets stored in the cache as part of a request for an identifier. The historical data may include data indicating when a data set was last accessed, e.g., prior to the current phase, in the current phase, or both. The historical data may be only for data sets that are not tagged, e.g., the data sets “f,” “d,” and “e,” for all of the data sets currently stored in the cache 102, or for another group of data sets that includes some of the data sets stored in the cache 102 and can include data sets stored in the memory 120 that are not stored in the cache.

As shown in FIG. 1, the cache 102 includes data sets {a, b, c, d, e}. At time T_{A}, data sets “c,” “d,” “e,” “f,” and “g” are stale, e.g., were accessed in the cache 102 during the previous phase and data sets “a,” “b,” and “c” are tagged as having been accessed during the current phase. The caching system 100 includes the data set chains 114 for a first group 116 with identifiers 118 for the data sets “c,” and “g;” and for a second group 116 with an identifier for the data set “f” (e.g., after having replaced the data set “f” in the cache with the data set “b” if continuing the example from above).

In response to receiving a request for the data set “f” during time period TA, the caching system 100 determines that the data set “f” is not currently stored in the cache 102. The caching system 100 requests and receives, during time period Tc, the requested data set “f” from the memory 120. The caching system 100 may determine that the requested data set was stale, e.g., using data stored in the caching system 100—either in the cache 102, a memory that includes the tag data 108, or in another memory. The caching system 100 may determine a data set chain that identifies the requested data, e.g., the second data set chain, in response to determining that the requested data set “f” is stale.

The caching system 100 may determine a quantity of data sets identified by the data set chain, e.g., one. The caching system 100 may determine whether the quantity satisfies a threshold value. The threshold value may be the harmonic number, Hₖ, or another value, e.g., Hₖ−1. In some examples, the caching system 100 may increment the quantity of data sets identified by the data set chain, e.g., to a value of two, and compare the incremented value with the threshold value. When the determined value satisfies the threshold value the caching system 100 uses an identifier received from the machine learning system 124 to determine a data set 106 from the cache 102 to evict. For instance, when the determined value is two, based on a length of one for the second data set chain that includes one identifier combined with an increment of one, and the threshold value is

$${H}_{5} = 2 \frac{17}{60} ,$$

the caching system 100 determines that a predicted eviction accuracy of the machine learning system 124 satisfies a threshold eviction accuracy. The caching system 100 requests and receives, from the machine learning system 124 during time period TD, identification of a data set 106 from the cache 102 for eviction to allow storage of the requested data set “f”' in the cache 102. The caching system 100 can then update the second data set chain to include an identifier for the evicted data set, store the data set “f” in the cache 102 in the cache location that previously included the evicted data set, and tag the data set “f” as having been accessed during the current phase.

If the caching system 100 receives, during time period T_{A}, a request for the data set “c” instead of the data set “f,” the caching system 100 may determine a predicted eviction accuracy for the machine learning system 124 using the first data set chain that includes an identifier 118 for the requested data set “c.” In this example, the caching system 100 determines that the first data set chain identifies two data sets and determines a modified value of three, e.g., by incrementing a value of two for the two identified data sets by one. The caching system 100 may compare the modified value with a threshold value to determine whether the modified value satisfies the threshold value. With a threshold value of

$${H}_{5} = 2 \frac{17}{60} ,$$

the caching system 100 determines that the modified value does not satisfy the threshold value, e.g., is greater than the modified value. Based on this result, the caching system 100 determines that the predicted eviction accuracy of the machine learning system 124 does not satisfy the threshold eviction accuracy and to use a different process to determine which data set, e.g., either the data set “d” or the data set “e” which are not tagged, to evict from the cache 102.

In some implementations, when the caching system 100 includes only one data set 106 that is not tagged 112, the caching system 100 may evict the one data set that is not tagged 112. For instance, the caching system 100 may receive a request for a data set that is not stored in the cache 102, determine that only one data set is not tagged, and evict the one data set that is not tagged without requesting an identifier from the machine learning system 124.

In some implementations, when the caching system 100 receives a request for a data set that is already stored in the cache 102, the caching system 100 determines whether to tag the requested data set as having been accessed during the current phase. For instance, the caching system 100 determines whether the requested data set was already tagged during the current phase, e.g., as would occur after receiving a second request for the data set “a,” or whether the requested data set has not been tagged during the current phase, e.g., as would occur after receiving a request for the data set “e.” If the caching system 100 determines that the requested data set was already tagged during the current phase, the caching system 100 determines to skip tagging the requested data set. If the caching system 100 determines that the requested data set has not been tagged during the current phase, the caching system 100 tags 112 the requested data set as having been accessed during the current phase.

In some implementations, when all data sets in the cache 102 are tagged as having been accessed during the current phase, the caching system 100 begins a new phase. When beginning a new phase, the caching system 100 removes the tags 112 for the data sets 106 stored in the cache 102 to indicate that the data sets 106 have not been accessed during the new phase. The caching system 100 may determine which data sets were accessed during the previous phase and store, in a memory, data indicating that those data sets were accessed during the previous phase.

The machine learning system 124 may use any appropriate type of machine learning process to determine a data set 106 stored in the cache 102 that is not tagged as having been accessed during the current phase as a recommended data set for eviction. For instance, the machine learning system 124 may use regression analysis 126 to determine a data set to recommend for eviction. The machine learning system 124 may include, for example, a neural network analysis system, a recurrent neural network analysis system, a long short-term memory analysis system, or a combination of two or more of these.

The caching system 100 can include several different functional components, including the cache 102, the tag data 108, and the data set chains 114. In some examples, the caching system 100 may include or be part of one or more processors, e.g., one or more data processing apparatuses. In these examples, the cache 102 may be a cache that caches data for at least one of the one or more processors. In some examples, the caching system 100 may include or be part of one or more computers, e.g., one or more data processing apparatuses. In these examples, the cache 102 may store data that is requested by the requesting system 128 as a client device. For instance, the caching system 100 may be part of a server system, e.g., a single server computer or multiple server computers operating in conjunction with one another, including, for example, a set of remote computers deployed as a cloud computing service. The server system may cache data, such as search results, requested by one or more client devices. The various functional components of the caching system 100 may be installed on one or more computers as separate functional components or as different modules of a same functional component.

The cache 102 may be a processor cache or a RAM. When the cache 102 is a processor cache, the memory 120 may be a RAM, a SSD, a HDD, multiple different memories, or a combination of two or more of these. When the cache 102 is a RAM, the memory 120 may be a SSD, a HDD, multiple different memories, or a combination of two or more of these.

The requesting system 128 may be any appropriate type of system. For instance, when the cache 102 is a processor cache, the requesting system 128 may be a motherboard that is physically connected to and provides power to the processor, or a peripheral device, e.g., a graphics card or a physics card. When the cache 102 is a cache for a computer, e.g., a search server, the requesting system 128 may include a personal computer, a mobile communication device, or another devices that can send and receive data over a network.

Table 1, below, shows an example eviction process for a cache 102 of size k. The cache C may initially be an empty cache (C←Ø). In some examples, the cache C may initially include one or more data sets, e.g., the cache C may include k data sets and be full. In table 1, r represents the current phase of the process; M represents the set of all marked, e.g., tagged, data sets that have been accessed during the current phase r; i represents a sequential index, e.g., round, for the request being processed in the phase; lᵣ represents a number of clean elements currently stored in the cache 102; S represents the set of all clean data sets; [symbol] ᵢ represents a requested data set, e.g., for storage in or retrieval from the cache C at round i; hᵢ represents a recommendation received from the machine learning system in round i which can be saved as recommendation p( [symbol] ᵢ), e.g., an identifier of a data set for eviction based on receipt of a request for [symbol] ᵢ; n(r,lᵣ) represents the quantity of data sets identified by a data set chain that was created upon storing the lᵣ^{th} clean element in the cache 102 for phase r; Ω(r, lᵣ) represents a particular element that has been added to a data set chain that was created upon storing the lᵣ^{th} clean element in the cache 102 for phase r; and Hₖ represents the harmonic number. [symbol] ᵢ ∈ C indicates whether the cache C is currently storing data set [symbol] ᵢ. |C|<k indicates whether a quantity |C| of data sets stored in the cache C is less than the size k of the cache C. C ∪{ [symbol] ᵢ} represents storage of data set [symbol] ᵢ in the cache C. |M| indicates a quantity of data sets in the set M of marked data sets. [symbol] ∈C−M represents the set of all data sets in the cache C that are not marked M. e=arg max [symbol] _{∈C-M}p( [symbol] ) represents a data set e to evict from the set of all data sets in the cache C that are not marked M and that has the highest predicted time p( [symbol] ) identified by the machine learning system, e.g., that is predicted to be accessed later than the other data sets [symbol] ∈C−M. [symbol] ᵢ∉ S indicates whether data set [symbol] ᵢ is not in the set S of clean data sets, e.g., is a stale data set.

TABLE 1
Example Eviction Process for a Cache C of size k.

| | |
|---|---|
| 1 | Initialize phase counter r ← 1, unmark all elements (M ← Ø), |
| | and set round i ← 1. |
| 2 | Initialize clean element counter lᵣ ← 0 and clean set S ← Ø. |
| 3 | Element zᵢ arrives and the machine learning system gives a |
| | prediction hᵢ. Save prediction p(zᵢ) ← hᵢ. |
| 4 | if zᵢ does not result in cache miss (zᵢ ∈ C or \|C\| < k) then |
| 5 | Add to cache C ← C ∪ {zᵢ} and go to step 26 |
| 6 | end if |
| 7 | if \|M\| = \|C\| (all cache elements are marked) then |
| 8 | Increase phase counter (r ← r + 1), initialize clean element |
| | counter (lᵣ ← 0), save cache as clean set (S → C) and unmark |
| | all elements (M ← ∅). |
| 9 | end if |
| 10 | if zᵢ is a clean element (zᵢ ∈ S) then |
| 11 | Increase number of clean elements lᵣ ← lᵣ + 1. |
| 12 | Initialize size of new clean chain: n(r, lᵣ) ← 1. |
| 13 | Select to evict unmarked element with highest predicted time |
| | identified by the machine learning system (e.g., e = arg |
| | max_{z∈C-M}p(z)). |
| 14 | end if |
| 15 | if zᵢ is a stale element (zᵢ ∉ S) then |
| 16 | It has appeared in some clean chain. Let c be this clean |
| | chain: zᵢ = ω(r, c). |
| 17 | Increase length of the clean chain n(r, c) ← n(r, c) + 1. |
| 18 | if n(r, c) ≤ 2Hₖ then |
| 19 | Select to evict the unmarked element with highest |
| | predicted time identified by the machine learning system |
| | (e.g., e = arg max_{z∈C-M}p(z)). |
| 20 | else |
| 21 | Select to evict a random unmarked element e ∈ C-M. |
| 22 | end if |
| 23 | Update cache by evicting e: C ← C ∪ {zᵢ} − {e}. |
| 24 | Set e as representative for the chain: ω(r, c) ← e. |
| 25 | end if |
| 26 | Mark incoming element (M ← M ∪ {zᵢ}), increase round |
| | (i ← i + 1), and go to step 3. |

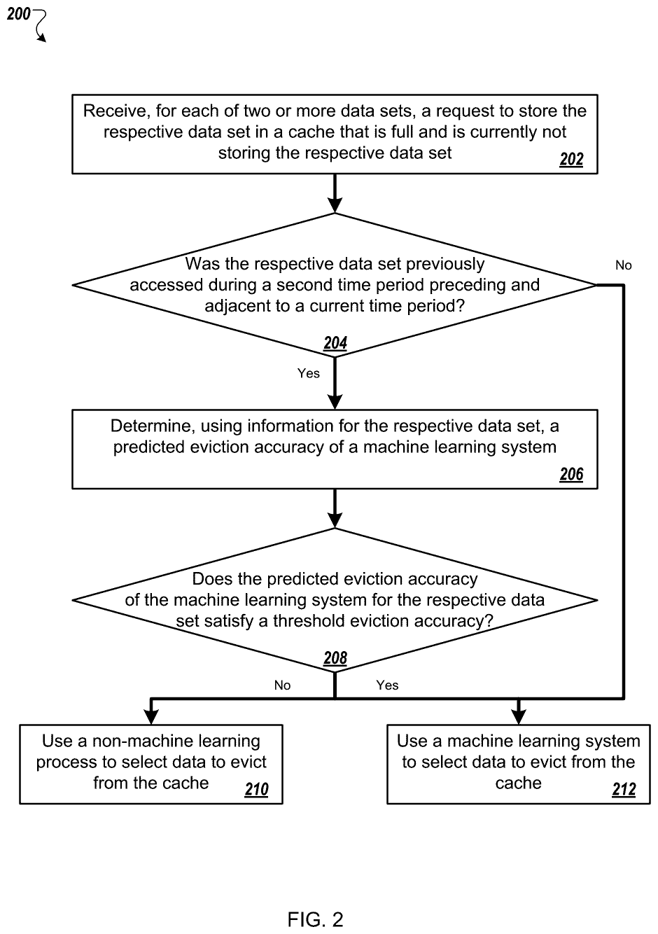

FIG. 2 is a flow diagram of a process 200 for determining a process to use to select data to evict from a cache. For example, the process 200 can be used by the caching system 100 shown in FIG. 1.

A caching system receives, for each of two or more data sets, a request to store the respective data set in a cache that is full and is currently not storing the respective data set (202). For instance, the caching system may determine to attempt to retrieve the respective data set from the cache for use in generating other data, to provide to another system, or for another process. As part of the data retrieval process, the caching system may receive a request to store the data in a cache.

The request to store the data in the cache may be performed automatically. For example, the request to store the data in the cache may be part of an automatic process in which a processor retrieves data and automatically stores the retrieved data in a processor cache.

In some examples, the request to store data may be part of a process in which a computer stores data responsive to a query. For instance, the computer, e.g., a server, may receive data responsive to a query prior to receipt of the query and store the received data in a cache, e.g., to cache data that satisfies a threshold likelihood of being requested from the computer. The request to store the data in a cache may be part of a process in which the computer receives a query, determines data responsive to the query, and stores the responsive data in a cache.

The caching system determines whether the respective data set was previously accessed during a second time period preceding and adjacent to a current time period (204). For example, the caching system determines whether the respective data set was accessed in a phase immediate prior to the current phase and is stale.

In response to determining that the respective data set was not previously accessed during the second time period preceding and adjacent to the current time period, the caching system uses a machine learning system to select data to evict from the cache (212). For instance, the caching system requests that the machine learning system select data for eviction from the cache. The caching system may request selection by the machine learning system of data that has not been accessed during the current time period.

In response to determining that the respective data set was previously accessed during the second time period preceding and adjacent to the current time period, the caching system determines, using information for the respective data set, a predicted eviction accuracy of a machine learning system (206). For example, the caching system may determine the predicted eviction accuracy using a data set chain that identifies the respective data set or another appropriate process.

The caching system determines whether the predicted eviction accuracy of the machine learning system for the respective data set satisfies a threshold eviction accuracy (208). For instance, the caching system determines whether the predicted eviction accuracy is greater than, equal to, or both, the threshold eviction accuracy.

In response to determining that the predicted eviction accuracy of the machine learning system for the respective data set does not satisfy the threshold eviction accuracy, the caching system uses a non-machine learning process to select data to evict from the cache (210). For example, the caching system randomly selects data to evict from the cache. The caching system may randomly select data that has not been accessed during the current time period.

In response to determining that the predicted eviction accuracy of the machine learning system for the respective data set satisfies the threshold eviction accuracy, the caching system uses a machine learning system to select data to evict from the cache (212). For instance, the caching system may use a regression analysis system or another appropriate machine learning system to select data to evict from the cache. The caching system may request selection by the machine learning system of data that has not been accessed during the current time period.

The order of steps in the process 200 described above is illustrative only, and determining the process to use to select data to evict from the cache can be performed in different orders. For example, the caching system can determine whether the predicted eviction accuracy satisfies the threshold eviction accuracy prior to determining whether a data set was accessed during the second time period.

In some implementations, the process 200 can include additional steps, fewer steps, or some of the steps can be divided into multiple steps. For example, the caching system may perform steps 202, 206-208, and 212 without performing the other steps in the process 200. In some examples, the caching system may perform steps 206 through 212 without performing the other steps in the process.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HyperText Markup Language (HTML) page, to a user device, e.g., for purposes of displaying data to and receiving user input from a user interacting with the user device, which acts as a client. Data generated at the user device, e.g., a result of the user interaction, can be received from the user device at the server.

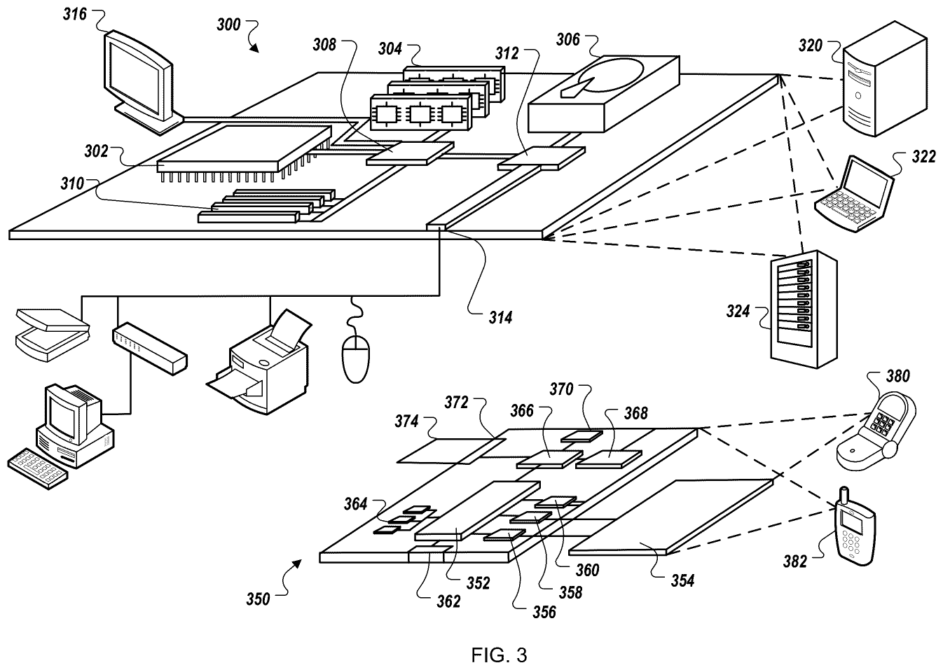

FIG. 3 is a block diagram of computing devices 300, 350 that may be used to implement the systems and methods described in this document, as either a client or as a server or plurality of servers. Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a computer-readable medium. In one implementation, the memory 304 is a volatile memory unit or units. In another implementation, the memory 304 is a non-volatile memory unit or units.

The storage device 306 is capable of providing mass storage for the computing device 300. In one implementation, the storage device 306 is a computer-readable medium. In various different implementations, the storage device 306 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer-or machine-readable medium, such as the memory 304, the storage device 306, or memory on processor 302.

The high speed controller 308 manages bandwidth-intensive operations for the computing device 300, while the low speed controller 312 manages lower bandwidth-intensive operations. Such allocation of duties is exemplary only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can process instructions for execution within the computing device 350, including instructions stored in the memory 364. The processor may also include separate analog and digital processors. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT

LCD display or an OLED display, or other appropriate display technology. The display interface 356 may comprise appropriate circuitry for driving the display 354 to present graphical and other information to a user. The control interface 358 may receive commands from a user and convert them for submission to the processor 352. In addition, an external interface 362 may be provided in communication with processor 352, so as to enable near area communication of device 350 with other devices. External interface 362 may provide, for example, for wired communication (e.g., via a docking procedure) or for wireless communication (e.g., via Bluetooth or other such technologies).

The memory 364 stores information within the computing device 350. In one implementation, the memory 364 is a computer-readable medium. In one implementation, the memory 364 is a volatile memory unit or units. In another implementation, the memory 364 is a non-volatile memory unit or units. Expansion memory 374 may also be provided and connected to device 350 through expansion interface 372, which may include, for example, a SIMM card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provided as a security module for device 350, and may be programmed with instructions that permit secure use of device 350. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 364, expansion memory 374, or memory on processor 352.

Device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, GPS receiver module 370 may provide additional wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound (e.g., voice messages, music files, etc.) and may also include sound generated by applications operating on device 350.

The computing device 350 may be implemented in a number of different forms, as shown in the figure. For example, it may be implemented as a cellular telephone 380. It may also be implemented as part of a smartphone 382, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A system comprising a data processing apparatus and one or more storage devices on which are stored instructions that are operable, when executed by the data processing apparatus, to cause the data processing apparatus to perform operations comprising:
determining that particular data is not stored in a cache that is full;
in response to determining that the particular data is not stored in the cache that is full, determining, by a caching process, whether to use a machine learning system or a non-machine learned caching process to evict data stored in the cache, wherein:
the machine learning system generates, as a prediction and by using a machine learned process, a memory address predicted by the machine learned process, the memory address being a memory location in the cache of a data set to evict from the cache; and
the non-machine learned caching process is separate from the machine learning system and generates a memory address as output, the memory address being a memory location of a data set in the cache to evict from the cache;
the determining of whether to use the machine learning system or the non-machine learned caching process comprising:
determining a predicted eviction accuracy that measures an accuracy of the prediction of the machine learning system in predicting that the data set to evict from the cache and addressed by the memory address will be used further in the future than the other data sets currently stored in the cache;
determining whether the predicted eviction accuracy of the machine learning system satisfies a threshold eviction accuracy;
in response to determining that the predicted eviction accuracy of the machine learning system satisfies the threshold eviction accuracy:
selecting, by the caching process, the machine learning system to predict a memory address of a data set stored in the cache to evict from the cache;
predicting, by the machine learned process of the machine learning system, the memory address of the data set stored in the cache to evict from the cache;
evicting, from the cache, the data set stored at the location of the memory address; and
storing the particular data in the cache at the memory location of the memory address; and
in response to determining that the predicted eviction accuracy of the machine learning system does not satisfy the threshold eviction accuracy:
determining, using a non-machine learning system, a memory address of a data set stored in the cache to evict from the cache;
evicting, from the cache, the data set stored at the location of the memory address; and
storing the particular data in the cache at the memory location of the memory address.

2. The system of claim 1, wherein determining a predicted eviction accuracy that measures an accuracy of the prediction of the machine learning system in predicting that the data set to evict from the cache and addressed by the memory address will be used further in the future than the other data sets currently stored in the cache comprises determining a predicted eviction accuracy based on a data set chain that includes data sets the machine learning system previously identified for eviction from the cache.

3. The system of claim 2, wherein predicting, by the machine learned process of the machine learning system, the memory address of the data set stored in the cache to evict from the cache comprises predicting a memory address for a date set stored in the cache that has not been accessed within a particular time period.

4. The system of claim 3, the operations comprising:
determining whether the particular data was previously stored in the cache during a second time period preceding and adjacent to the particular time period without any intervening time periods; and
in response to determining that the particular data was not previously stored in the cache during the second time period, creating a new data set chain that identifies the data stored in the cache for which the memory address was predicted by the machine learning system.

5. The system of claim 4, the operations comprising:
in response to determining that the particular data was previously stored in the cache during the second time period:
determining a data set chain that identifies the particular data; and
updating the data set chain to identify the data stored in the cache for which the memory address was predicted by the machine learning system; and
wherein determining the predicted eviction accuracy comprises determining the predicted eviction accuracy using a quantity of data sets identified by data set chain.

6. The system of claim 5, wherein the machine learned process is one of a neural network analysis system, a recurrent neural network analysis system, or a long short-term memory neural network system that is trained to predict the memory address that is the memory location in the cache of the data set to evict from the cache.

7. A computer-implemented method, comprising:
determining that particular data is not stored in a cache that is full;
in response to determining that the particular data is not stored in the cache that is full, determining, by a caching process, whether to use a machine learning system or a non-machine learned caching process to evict data stored in the cache, wherein:
the machine learning system generates, as a prediction and by using a machine learned process, a memory address predicted by the machine learned process, the memory address being a memory location in the cache of a data set to evict from the cache; and
the non-machine learned caching process is separate from the machine learning system and generates a memory address as output, the memory address being a memory location of a data set in the cache to evict from the cache;
the determining of whether to use the machine learning system or the non-machine learned caching process comprising:
determining a predicted eviction accuracy that measures an accuracy of the prediction of the machine learning system in predicting that the data set to evict from the cache and addressed by the memory address will be used further in the future than the other data sets currently stored in the cache;
determining whether the predicted eviction accuracy of the machine learning system satisfies a threshold eviction accuracy;
in response to determining that the predicted eviction accuracy of the machine learning system satisfies the threshold eviction accuracy:
selecting, by the caching process, the machine learning system to predict a memory address of a data set stored in the cache to evict from the cache;
predicting, by the machine learned process of the machine learning system, the memory address of the data set stored in the cache to evict from the cache;
evicting, from the cache, the data set stored at the location of the memory address; and
storing the particular data in the cache at the memory location of the memory address; and
in response to determining that the predicted eviction accuracy of the machine learning system does not satisfy the threshold eviction accuracy:
determining, using a non-machine learning system, a memory address of a data set stored in the cache to evict from the cache;
evicting, from the cache, the data set stored at the location of the memory address; and
storing the particular data in the cache at the memory location of the memory address.

8. The method of claim 7, wherein determining a predicted eviction accuracy that measures an accuracy of the prediction of the machine learning system in predicting that the data set to evict from the cache and addressed by the memory address will be used further in the future than the other data sets currently stored in the cache comprises determining a predicted eviction accuracy based on a data set chain that includes data sets the machine learning system previously identified for eviction from the cache.

9. The method of claim 8, wherein predicting, by the machine learned process of the machine learning system, the memory address of the data set stored in the cache to evict from the cache comprises predicting a memory address for a date set stored in the cache that has not been accessed within a particular time period.

10. The method of claim 9, further comprising:
determining whether the particular data was previously stored in the cache during a second time period preceding and adjacent to the particular time period without any intervening time periods; and
in response to determining that the particular data was not previously stored in the cache during the second time period, creating a new data set chain that identifies the data stored in the cache for which the memory address was predicted by the machine learning system.

11. The method of claim 10, further comprising:
in response to determining that the particular data was previously stored in the cache during the second time period:
determining a data set chain that identifies the particular data; and
updating the data set chain to identify the data stored in the cache for which the memory address was predicted by the machine learning system; and
wherein determining the predicted eviction accuracy comprises determining the predicted eviction accuracy using a quantity of data sets identified by data set chain.

12. The method of claim 7, wherein the machine learned process is one of a neural network analysis system, a recurrent neural network analysis system, or a long short-term memory neural network system that is trained to predict the memory address that is the memory location in the cache of the data set to evict from the cache.

13. A non-transitory computer storage medium encoded with instructions that, when executed by a data processing apparatus, cause the data processing apparatus to perform operations comprising:
determining that particular data is not stored in a cache that is full;
in response to determining that the particular data is not stored in the cache that is full, determining, by a caching process, whether to use a machine learning system or a non-machine learned caching process to evict data stored in the cache, wherein:
the machine learning system generates, as a prediction and by using a machine learned process, a memory address predicted by the machine learned process, the memory address being a memory location in the cache of a data set to evict from the cache; and
the non-machine learned caching process is separate from the machine learning system and generates a memory address as output, the memory address being a memory location of a data set in the cache to evict from the cache;
the determining of whether to use the machine learning system or the non-machine learned caching process comprising:
determining a predicted eviction accuracy that measures an accuracy of the prediction of the machine learning system in predicting that the data set to evict from the cache and addressed by the memory address will be used further in the future than the other data sets currently stored in the cache;
determining whether the predicted eviction accuracy of the machine learning system satisfies a threshold eviction accuracy;
in response to determining that the predicted eviction accuracy of the machine learning system satisfies the threshold eviction accuracy:
selecting, by the caching process, the machine learning system to predict a memory address of a data set stored in the cache to evict from the cache;
predicting, by the machine learned process of the machine learning system, the memory address of the data set stored in the cache to evict from the cache;
evicting, from the cache, the data set stored at the location of the memory address; and
storing the particular data in the cache at the memory location of the memory address; and
in response to determining that the predicted eviction accuracy of the machine learning system does not satisfy the threshold eviction accuracy:
determining, using a non-machine learning system, a memory address of a data set stored in the cache to evict from the cache;
evicting, from the cache, the data set stored at the location of the memory address; and
storing the particular data in the cache at the memory location of the memory address.

14. The non-transitory computer storage medium of claim 13, wherein determining a predicted eviction accuracy that measures an accuracy of the prediction of the machine learning system in predicting that the data set to evict from the cache and addressed by the memory address will be used further in the future than the other data sets currently stored in the cache comprises determining a predicted eviction accuracy based on a data set chain that includes data sets the machine learning system previously identified for eviction from the cache.

15. The non-transitory computer storage medium of claim 14, wherein predicting, by the machine learned process of the machine learning system, the memory address of the data set stored in the cache to evict from the cache comprises predicting a memory address for a date set stored in the cache that has not been accessed within a particular time period.

16. The non-transitory computer storage medium of claim 15, the operations comprising:
determining whether the particular data was previously stored in the cache during a second time period preceding and adjacent to the particular time period without any intervening time periods; and
in response to determining that the particular data was not previously stored in the cache during the second time period, creating a new data set chain that identifies the data stored in the cache for which the memory address was predicted by the machine learning system.

17. The non-transitory computer storage medium of claim 16, the operations comprising:
in response to determining that the particular data was previously stored in the cache during the second time period:
determining a data set chain that identifies the particular data; and
updating the data set chain to identify the data stored in the cache for which the memory address was predicted by the machine learning system; and
wherein determining the predicted eviction accuracy comprises determining the predicted eviction accuracy using a quantity of data sets identified by data set chain.

18. The non-transitory computer storage medium of claim 13, wherein the machine learned process is one of a neural network analysis system, a recurrent neural network analysis system, or a long short-term memory neural network system that is trained to predict the memory address that is the memory location in the cache of the data set to evict from the cache.
